(19) United States
(12) Patent Application Publication
(10) Pub. No.: US 2007/0020970 A1
(43) Pub. Date: Jan. 25, 2007

(54) Pool Tool Organizer

(76) Inventor: Marc C. Miller, Bradenton, FL (US)

Correspondence Address: SMITH HOPEN, PA, 180 PINE AVENUE NORTH, OLDSMAR, FL, 34677, US

(21) Appl. No.: 11/458,538

(22) Filed: Jul. 19, 2006

Related U.S. Application Data
(60) Provisional application No. 60/700,996, filed on Jul. 20, 2005.

(51) Int. Cl. H01R 12/00

(52) U.S. Cl. 439/78

(57) ABSTRACT

A pool tool organizer with a base having a first surface adapted to receive at least one tool (such as a hose) with at least one receptacle extending upward from the base, and at least one receptacle extending downward from the first base. The base is adapted to be attached to a substantially perpendicular surface; although a stand can be employed to hold the base at a predetermined height. The storage device as at least one receptacle extending upward from the base and/or at least one receptacle extending downward from the base. In yet another embodiment the device has at least one receptacle extending outward from the base in substantially parallel relation to said base. The receptacles can be formed with a substantially circular aperture to receive a bearing common on most pool tools.

### CROSS REFERENCE TO RELATED APPLICATIONS

This application claims priority to currently pending U.S. Provisional Patent Application 60/700,996, filed Jul. 20, 2005.

### FIELD OF INVENTION

The invention relates generally to swimming pool maintenance equipment. Specifically, the invention provides a means of securing and storing such equipment.

### BACKGROUND OF THE INVENTION

The storage of swimming pool equipment poses a nuisance as the equipment is often unwieldy and, more importantly, unsightly. The equipment, commonly including vacuum cleaner heads, nets, brushes, etc. usually connect the extension pole or hose via a depressible bearing that engages a hole on the extension pole and/or hose.

Other inventions have attempted to create a storage device for such equipment, for example:

U.S. Pat. No. 6,523704 to Sanders describes a system of tubular extension formed at an acute angle to a tubular base. As the tubular base is narrow, the equipment is stored in a linear fashion that is one right above the next. This formation does not adequately address the varying shape of different pool equipment, such as the flexible hose, and places all tools in proximity where they can interfere with one another.

U.S. Pat. No. 5,765,699 to Griffin describes an elongate tool rack comprised of a plurality of spaced brackets and a support bar. The brackets are U-shaped for holding the various equipment items. The '699 patent requires a wide horizontal surface to which the rack must be affixed.

Therefore, what is needed is a compact pool equipment organizational tool that stores equipment efficiently, while keeping the items sufficiently spaced apart to be easily, and independently, removed from the rack.

### SUMMARY OF INVENTION

In a first embodiment, the inventive storage device comprises a base having a first surface adapted to receive at least one tool with at least one receptacle extending upward from the base, and at least one receptacle extending downward from the first base. The first surface of the base is substantially horizontal, and substantially flat, so that equipment can be placed thereon.

In an alternative embodiment the first surface is curved, and can be adapted to have an angular or semi-circular profile. In most embodiments the base is adapted to be attached to a substantially perpendicular surface; although a stand can be employed to hold the base independently, and at a predetermined height.

In another embodiment, the storage device comprises at least one receptacle extending upward from the base and/or at least one receptacle extending downward from the base. In yet another embodiment the device has at least one receptacle extending outward from the base in substantially parallel relation to said base. The receptacles of the alternative embodiments can be formed with an aperture to receive a bearing common on most pool tools.

The storage device can further include, in other embodiments, at least one latch for receiving a tool, such as a pole, and/or a faceplate in substantially perpendicular relation to the base. The faceplate extends upward in relation to the base to prevent tools, or a hose, placed on the surface of the base from sliding forward.

### BRIEF DESCRIPTION OF THE DRAWINGS

For a fuller understanding of the invention, reference should be made to the following detailed description, taken in connection with the accompanying drawings, in which:

FIG. 1 is an isometric view of the inventive storage device.

FIG. 2 is an isometric view of an alternate embodiment of the inventive storage device showing how a pool tool is attached.

FIG. 3 is a cross section view of the inventive device.

FIG. 4 is a front perspective view of the inventive device with a hose resting thereon and a vacuum head attached thereto.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The present invention includes a storage apparatus having particular utility for swimming pool maintenance equipment. Receptacles, formed as tubular extensions, extend from a base and are provided to receive various items associated with pool maintenance. The extending receptacles have a diameter slightly greater or less than the tubular portion common to most pool equipment. The base is adapted to receive a hose.

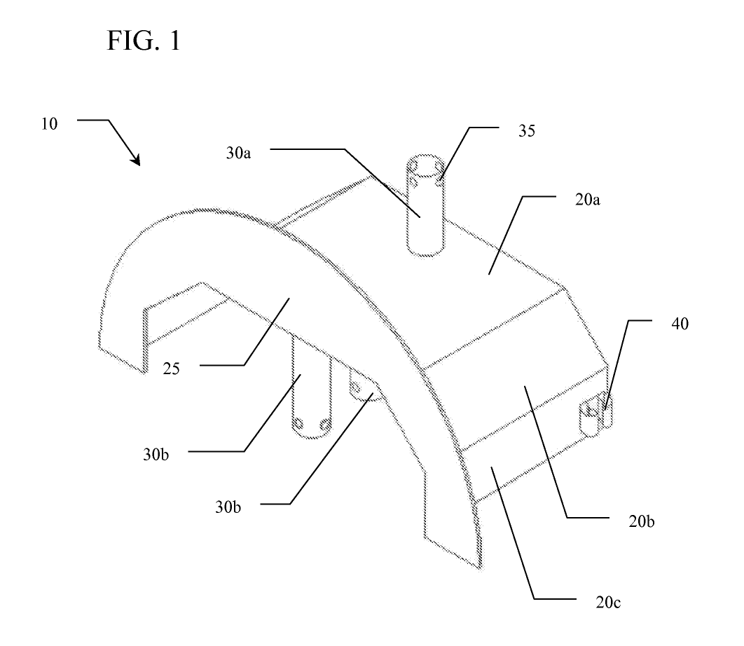

Turning now to FIG. 1, showing a general embodiment of storage device 10. In this embodiment, device 10 comprises base 20 having a first surface 20a, which is substantially horizontal. Second surface 20b and 20c are optional and are adapted to provide a curved, or angular, profile to base 20; the angles shown in FIG. 1 are illustrative and other angles are envisioned. Base 20 can also be created from a single, arcuate material having only a first surface; thereby defining, at least, a substantially semi-circular profile. Preferably, any profile (whether circular or semi-circular) will have at least one flattened portion to support tools or otherwise accommodate a hose. Base 20, as well as the surfaces thereof, can be constructed from various materials including, but not limited to, PVC (or other plastic material), metal, wood or any material known in the art.

Base 20 is most commonly adapted to be affixed to a substantially perpendicular surface; such as a wall, fence or support strut for a screen enclosure. Base 20 is equipped with hardware to affix it to the desired location. Alternatively, base 20 can be provided with a stand (not shown) which allows greater variety in its placement, as well as portability.

Returning to FIG. 1, receptacles 30 extend from base 20 in substantially perpendicular relation. As shown in FIG. 1, receptacles 30 extend in super relation (receptacle 30a) and inferior relation (receptacle(s) 30b) to first surface 20a. The device is not limited to the orientation shown in FIG. 1 and can include multiple receptacles on either side of base 20.

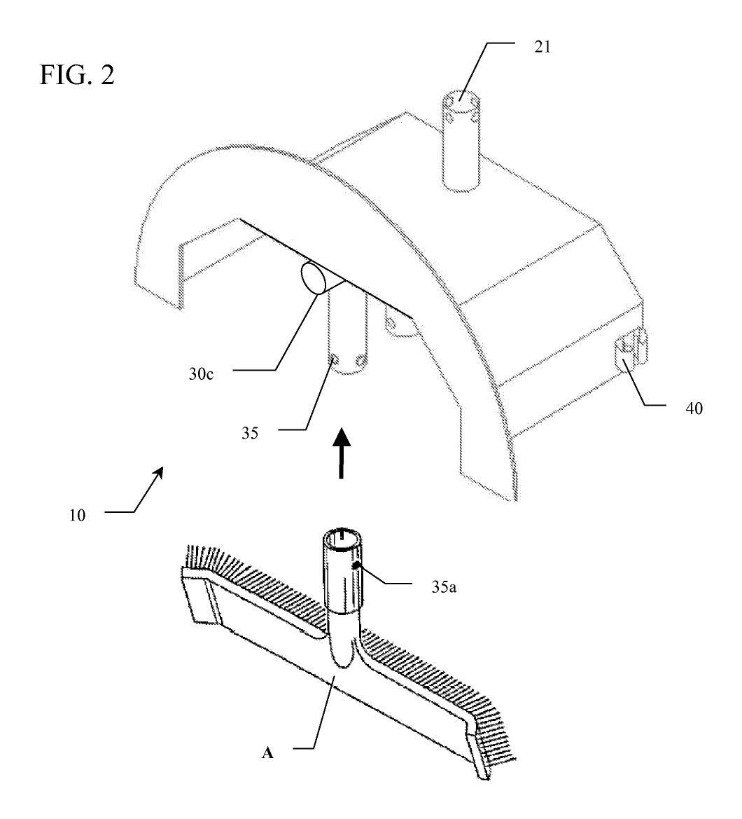

In one embodiment shown in FIG. 2, receptacles 30 are equipped with holes 35 to receive tension-bearing 35a on pool tool A, here a brush, which fastens it to the pole or hose when in use. Alternatively, a cam mechanism can be adapted to the end of the receptacles to secure the tools thereto.

In an illustrative embodiment, receptacles 30 are generally tubular. As with base 20, receptacles 30 can be formed from a variety of materials. Where, as shown here, the receptacles are formed as tubes they are equipped with apertures 21 at their distal ends (relative to base 20. Aperture 21 is formed to accept that end of the pool equipment which is usually inserted in a pole or hose; which is common in the art. As such, receptacles 30 and apertures 21 are sized to be approximately the same as the receiving end of a pole or hose commonly used in pool maintenance (i.e. 1¼ inch in diameter). As such, receptacles 30 are capable of receiving pool tool A, i.e. a brush, skimmer, vacuum head or any other pool equipment common in the art that fit within, or over, receptacles 30. While tubular receptacles accommodate the widest variety of tools, other shapes are contemplated and can be added as needed (i.e. with an adapter formed to fit the tubular extension on one end and the unique shape of the pool equipment on the other). As used herein, a receptacle includes a hollow or substantially hollow extension formed to mate with an article of pool maintenance.

As shown in FIG. 2, receptacle 30c is formed in substantially perpendicular relation to base 20. While FIGS. 1 and 2 show receptacles at orthogonal angles to base 20, other angles are contemplated and may be used. Receptacles 30 can be formed as part of base 20, by molding the receptacles with the base. Alternatively, receptacles 30 can be affixed to the base by any means known in the art.

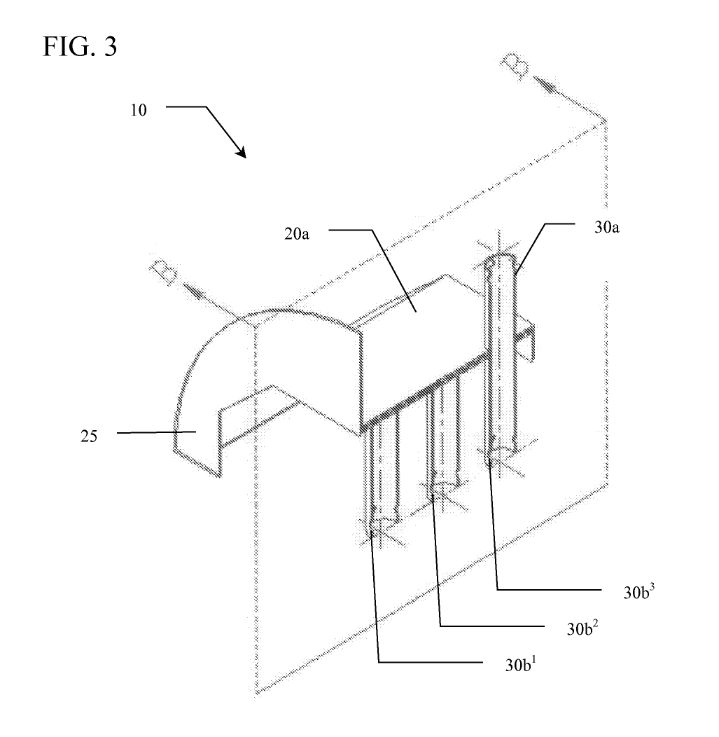

FIG. 3 is a cross section of device 10 cut along plane B. In this embodiment, a single receptacle 30a extends upward from surface 20a whereas a total of three receptacles (30b¹ through 30b³) depend there from. In alternative embodiments, any number of receptacles can be used on either side of base 20. Moreover, it is not necessary for an upward extending receptacle to be integral with the depending receptacle that may be directly beneath it (see upward extending receptacle 30a in relation to depending receptacle 30b³).

In most embodiments receptacles will be approximately the same size and shape and will be equally spaced apart; although this is not necessary. Receptacles of varying length, diameter, shape (cross-section) or other characteristics may be employed within a single device.

In addition to receptacles 30, device 10 is equipped with clips 40 (see FIGS. 1 and 2). Clips 40 are adapted to receive tools from the side rather than at their, most commonly tubular, ends. Clips 40 can be constructed from any material with sufficient resilience to be deformed by, and retain, the pool equipment. For example, clips 40 can be in the form of spring-tensioned metal brackets. Most commonly, clips 40 are used to hold the pole to which the remaining tools are attached during use. Clips 40 are not limited to tension devices and can also be belts, latches or hook and loop fasteners.

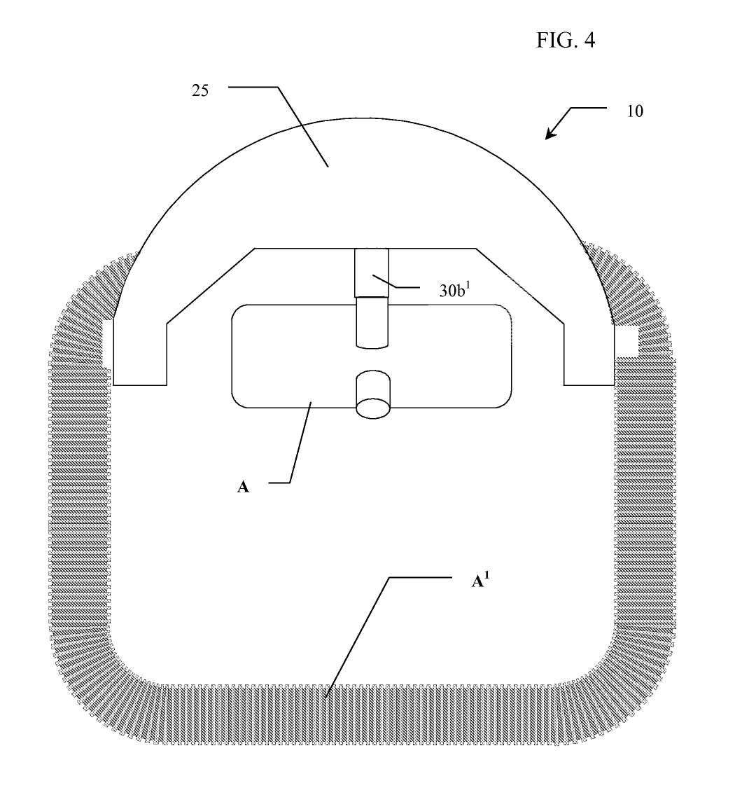

Device 10 can also be equipped with faceplate 25 formed at its leading end. Faceplate 25 can be constructed from a solid material, as shown in the figures, or of a mesh-like or otherwise breathable material (which may help facilitate drying of tools placed on surface 20a). Faceplate 25 provides a means of preventing tools, i.e. hose A¹ (see FIG. 4), placed on surface 20a from falling.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. A storage device, comprising:
a base having a first surface adapted to receive at least one tool;
at least one receptacle extending upward from the base; and
at least one receptacle extending downward from the first base.

2. The storage device of claim 1 wherein the first surface of the base is substantially horizontal.

3. The storage device of claim 1 wherein the first surface of the base is substantially flat.

4. The storage device of claim 1 wherein the base is curved.

5. The storage device of claim 1 wherein the base is adapted to be attached to a substantially perpendicular surface.

6. The storage device of claim 1 further comprising a stand adapted to hold the base at a predetermined height.

7. The storage device of claim 1 further comprising at least one receptacle extending upward from the base.

8. The storage device of claim 1 further comprising at least one receptacle extending downward from the base.

9. The storage device of claim 1 further comprising at least receptacle extending outward from the base in substantially parallel relation to said base.

10. The storage device of claim 1 wherein at least one receptacle extending from the base has a substantially circular aperture to receive bearing on a tool.

11. The storage device of claim 1 further comprising at least one latch for receiving a tool.

12. The storage device of claim 1 further comprising a faceplate in substantially perpendicular relation to the base.

13. The storage device of claim 12 wherein the faceplate extends upward in relation to the base.
